(19) United States
(12) Patent Application Publication
(10) Pub. No.: US 2025/0044308 A1
(43) Pub. Date: Feb. 6, 2025

(54) TRANSPORT ARRANGEMENT AND METHOD FOR TRANSPORTING A TEST STRIP

(71) Applicant: OLYMPUS WINTER & IBE GMBH, Hamburg (DE)

(72) Inventors: Alexander Werner, Bielefeld (DE); Martin Schnieders, Bielefeld (DE); Celina Werner, Bochum (DE); Gregor Goldberg, Warendorf (DE)

(73) Assignee: OLYMPUS WINTER & IBE GMBH, Hamburg (DE)

(21) Appl. No.: 18/792,791

(22) Filed: Aug. 2, 2024

Related U.S. Application Data
(60) Provisional application No. 63/530,490, filed on Aug. 3, 2023.

(51) Int. Cl. G01N 35/00; G01N 21/77; G01N 21/78; G01N 35/10

(52) U.S. Cl. CPC G01N 35/00029; G01N 35/0099; G01N 35/1011; G01N 2021/7759; G01N 21/78; G01N 2035/00108

(57) ABSTRACT

A transport apparatus for transporting at least one test strip including: a gripper configured to grip a portion of the at least one test strip; wherein the gripper is arranged to move the test strip between at least a first dosing position and a second measuring position.

### CROSS-REFERENCE TO RELATED APPLICATION

The present application is based upon and claims the benefit of priority from U.S. Provisional Application No. 63/530,490 filed on Aug. 3, 2023, the entire contents of which is incorporated herein by reference.

The present application is related to the following co-pending U.S. applications, each filed on Aug. 2, 2024, U.S. patent application Ser. No. ______ (corresponding to U.S. Provisional Patent Application 63/530,492); U.S. patent application Ser. No. ______ (corresponding to U.S. Provisional Patent Application 63/530,496); U.S. patent application Ser. No. ______ (corresponding to U.S. Provisional Patent Application 63/530,500); and U.S. patent application Ser. No. ______ (corresponding to U.S. Provisional Patent Application 63/530,504); the entire contents of each of which is incorporated herein by reference.

### BACKGROUND

### Field

The present disclosure relates to a transport arrangement for transporting a test strip, such as one single test strip, an arrangement for measuring a concentration of reprocessing agents in a reprocessing liquid used in a reprocessing apparatus for medical instruments, a reprocessing apparatus for medical instruments, a transport method for transporting a test strip, such as one single test strip, and a measuring method for automatically measuring a concentration of reprocessing agents in a reprocessing liquid used in a reprocessing apparatus for medical instruments.

### Prior Art

Test strips are often used in analysis units for detecting cleaning, sterilization and/or disinfection agents, for example for measuring a concentration of reprocessing agents. Such analysis units may be used, for example, in water-bearing household appliances are known, for example, from DE 102009027950 A1. This document relates to a household device having a control device for performing rinse cycles, which are adjusted by the control device using cleaning agents e.g. additives. An analyzing unit detects the cleaning agents and is provided with a reading unit for radio frequency identification of barcode or other identification marks printed on the cleaning agents. The analyzing unit is connected with the control device for transmitting analyzing data from the analyzing unit to the control unit.

Furthermore, EP 3302210 B1 discloses a device and a method for determining the composition of the dirt load in a rinsing or detergent solution in a water-using household appliance, for example in a dishwasher, using near infrared spectroscopy (NIR).

Patent application DE 19806559 B4 discloses a method involving emitting rays into a dish stack, determining and/or recording a quantity or rays of at least one wavelength range, leaving the stack under respectively one predetermined angle, assuming a kind and a concentration of a pollution ratio and/or a cleaner ratio of the dish stack, and optimizing a dish washer program, accordingly. A corresponding dish washer arrangement is also disclosed.

Patent application DE 102007011119 A1 relates to a washing machine with an automatic controller for washing process and optical sensor devices. The optical sensor devices transmit signals, which are evaluated for controlling the washing process. The optical sensor devices detect light intensities of different spectral regions. The optical sensor devices are sensitive over the entire spectral region from infrared to ultraviolet. The optical sensor devices are arranged at a bypass such that the optical sensor devices measure characteristics of detergent components in different positions.

Existing solutions for measuring a concentration of reprocessing agents in a reprocessing liquid, however, usually are comparatively expensive and often require the use of specialized chemicals. Further, existing solutions are often operated fully or partly manually and/or are not always accurate and robust against operating errors. For example, existing solutions for measuring a concentration of reprocessing agents in a reprocessing liquid are often not suitable or reliable enough for specific areas of application.

### SUMMARY

Therefore, an object is to provide a solution, which reduces or eliminates one or more of the above-mentioned disadvantages. For example, an object is to provide an improved transport arrangement for transporting a test strip and an improved transport method for transporting a test strip, which are reliable, cost-efficient, and less sensitive to operation errors.

According to a first embodiment, a transport arrangement for transporting a test strip is provided, such as a transport arrangement for transporting one single test strip. The transport arrangement comprising a gripper configured to grip a test strip, such as the one single test strip, where a portion or end of the test strip opposite the portion of end of the test strip can contain a test surface; wherein the gripper is arranged to move the test strip between a first, dosing position and a second, measuring position, and can further move the test strip to a third, relocation position.

In the following, initially the transport arrangement for transporting a test strip, such as the one single test strip, and its components, functions and advantageous embodiments will be described.

Reprocessing as used herein may comprise all steps necessary to reuse previously used medical instruments, including removing blood, tissue and other biological debris and inactivating infectious microorganisms and/or viruses. For example, reprocessing may encompass, but is not limited to, initial basic and subsequent thorough cleaning, and/or disinfecting, and/or sterilizing the medical instruments using suitable cleaning, and/or disinfecting, and/or sterilizing agents. Reprocessing may also encompass re-packaging and of terminally sterilizing the previously cleaned, and/or disinfected, and/or sterilized medical instruments. Reprocessing agents may comprise reprocessing chemicals, for example peracetic acids. A reprocessing cycle may encompass a procedure, carried out, for example, in a reprocessing apparatus, used to reprocess a medical instrument between two uses. A reprocessing cycle may encompass a process of cleaning and/or rinsing and/or disinfection and/or sterilization.

Medical instruments as used herein can encompass endoscopes and/or probes, for example, and further specified medical instruments that may be reusable, such as reusable endoscopes and/or reusable probes.

The reprocessing of medical instruments is particularly sensitive for the safety of medical procedures using such medical instruments and thus highest requirements for the reliability of such reprocessing apply. For example, the requirements in reprocessing medical instruments differ from and exceed those for water-bearing household appliances, such as dishwashers and washing machines, by far and significantly. Therefore, solutions for such water-bearing household appliances are not suitable or sufficient for the requirements applying to the reprocessing of medical instruments between different medical procedures on different patients.

In order to ensure reliability and accuracy of reprocessing procedures and/or in order to monitor and/or document the conditions of reprocessing procedures, arrangements for measuring a concentration of reprocessing agents in a reprocessing liquid used in a reprocessing apparatus for medical instruments may be applied. Such an arrangement can comprise a measuring system which can be configured to evaluate a test surface of a test strip that has been exposed to a dose of reprocessing liquid.

The solution described herein considers that the handling of test strips, such as during dosing and measuring, can be partly or fully automated. Handling of test strips may comprise movement of test strip, such as to and from a first, dosing position and a second, measuring position and/or release and/or supply of test strips to a measuring system and/or transport of test strips. The solution described herein can be utilized since it allows to handle, such as transport, a single test strip as opposed to a plurality of test strips, which may be provided in a packaging, for example, and are thus easier to handle than a single, or individual test strip.

The transport arrangement provided herein can comprise a gripper configured for gripping a test strip, such as in a manner not interfering with the test surface, and positioning the test strip in different positions, such as a first, dosing position and a second, measuring position, and can also position the test strip in a third, relocation position. The first position can serve to have an amount of reprocessing liquid dosed onto the test surface. The second position can serve to evaluate, such as via an evaluation unit, the test surface after exposure to the reprocessing liquid. The third position can serve to relocate the test strip. This may include supplying the test strip to a measurement system, such as to the first and/or second positions, and/or discharging the test strip.

According to an embodiment, the gripper can be arranged moveably, such as translationally moveably, along a longitudinal axis. In a further embodiment, the first, dosing position, the second, measuring position, and/or the third, relocation position can be located along the longitudinal axis. The gripper can be moveable, such as translationally moveable, along the longitudinal axis via a translational drive, such as a linear drive. The gripper can be coupled to the translational drive via a coupling rod.

These embodiments can provide for a cost-efficient and reliable way to move the test strip between the first, dosing and second, measuring, and third, relocation position.

The gripper can be arranged rotatably about a rotation axis. The gripper can be rotatable about the rotation axis via a rotational drive. The gripper can be arranged to be rotatable to a first rotational, supply position and a second rotational, operational position, and/or also a third rotational, discharge position.

While the first, dosing and second, measuring, and/or third, relocation position can be located and moved along a longitudinal axis, a first rotational, supply position and a second rotational, operational position, and/or a third rotational, discharge position, which are located and moved about a rotation axis can also be used. In this way, a cost-effective, reliable and space-saving solution to provide for different positions and combinations thereof is possible.

In a further embodiment, the gripper can be configured to be positioned in the first, dosing position and the second, measuring position, and/or the third, relocation position, and any other position along the longitudinal axis within an overall translational or longitudinal stroke, independent from the rotational orientation of the gripper. Further, the gripper can be configured to be positioned in first rotational, supply position and the second rotational, operational position, and/or the third rotational, discharge position, and any other rotational position about the rotational axis within an overall rotational stroke, independent from the translational or longitudinal position of the gripper.

These embodiments can combine translational and rotational movement of the gripper to provide for different positions and different combinations thereof.

In a further embodiment, the gripper can comprise two gripper jaws, wherein the two gripper jaws can be movable from a gripping position to a release position and vice versa, such as via a gripping drive. The gripper with gripper jaws can be configured to securely grip and hold, also during movement, a test strip, such as the portion or end of the test strip opposite the portion of end of the test strip containing a test surface.

In an embodiment, the transport arrangement can comprise a controller comprising hardware. The controller can be configured to carry out the transport method described herein.

According to a further embodiment, an arrangement for measuring a concentration of reprocessing agents in a reprocessing liquid used in a reprocessing apparatus for medical instruments can be provided. The arrangement can comprise a transport arrangement for transporting a test strip, such as one single test strip, as described herein.

According to a further embodiment, a reprocessing apparatus for medical instruments can be provided. The reprocessing apparatus can comprise a reprocessing chamber; a reprocessing circuit; an arrangement for measuring a concentration of reprocessing agents in a reprocessing liquid; and a transport arrangement as described herein, for transporting a test strip, such as one single test strip, to the arrangement for measuring a concentration of reprocessing agents in a reprocessing liquid.

According to a further embodiment, a transport method for transporting a test strip, such as one single test strip is provided. The transport method can comprise gripping a test strip; moving, such as translationally or longitudinally, the test strip between a first, dosing position and a second, measuring position, and/or a third, relocation position, such as along a longitudinal axis.

The transport method can further comprise rotating the test strip between a first rotational, supply position and a second rotational, operational position, and/or a third rotational, discharge position, such as about a rotational axis.

Further, the transport method can comprise releasing the test strip in the third rotational, discharge position.

The gripping of the test strip can occur in the first rotational, supply position, such as in an arrangement for separating test strips from a test strip depot.

According to a further embodiment, a measuring method for automatically measuring a concentration of reprocessing agents in a reprocessing liquid used in a reprocessing apparatus for medical instruments is provided. The measuring method can comprise the transport method for transporting a test strip, such as one single test strip, as described herein; wherein the first, dosing position and the second, measuring position are located within an arrangement for measuring a concentration of reprocessing agents in a reprocessing liquid used in a reprocessing apparatus for medical instruments, such as within a measuring system of the arrangement for measuring a concentration of reprocessing agents in a reprocessing liquid used in a reprocessing apparatus for medical instruments.

The measuring method may further comprise checking the plausibility of an evaluation result and/or a determined characteristic and replacing the test strip in case of an implausible evaluation result and/or an implausible determined characteristic.

Further, the replacing the test strip can comprise removing the test strip from the measuring system; and providing a new test strip to the measuring system.

In a further embodiment of the measuring method, the removing of the test strip from the measuring system can comprise moving the gripper unit to the third, relocation position; rotating the gripper to the third rotational, discharge position; and moving the two gripper jaws to the release position.

Providing a new test strip to the measuring system can comprise rotating the gripper to the first rotational, supply position; moving the two gripper jaws to the gripping position to grip the new test strip, such as in an arrangement for separating test strips from a test strip depot; rotating the gripper to the second rotational, operational position; moving the gripper to the first, dosing position; and moving the gripper to the second, measuring position.

In a further embodiment of the measuring method, the checking of the plausibility of an evaluation result and/or a determined characteristic can comprise comparing the evaluation result with a plausibility reference value and/or comparing the determined characteristic with a plausibility reference characteristic; and can further comprise generating a plausibility error message in case an implausible evaluation result and/or an implausible determined characteristic occurs a predetermined number of times, such as once, twice or several times.

Further, the providing of a new test strip to the measuring system can comprise checking the initial state of the new test strip, such as in the second, measuring position and/or prior to moving the new test strip to the first, dosing position, such as prior to dosing a predetermined amount of reprocessing liquid onto the test surface.

In a further embodiment of the measuring method, the checking of the initial state of the new test strip can comprise measuring the initial state of the new test strip by using an evaluation unit, such as an optical spectrometer and/or an RGB color sensor; and/or measuring the initial state of the new test strip by determining an initial state characteristic, such as a color characteristic, of the test surface of the new test strip; and/or comparing the initial state result with an initial state reference value, such as two initial state reference values, and/or comparing the determined initial state characteristic with an initial state reference characteristic, such as two initial state reference characteristics; and/or generating an initial state error message in case the initial state result and/or comparing the determined initial state characteristic does not meet the initial state reference value, such as two initial state reference values, and/or the initial state reference characteristic, such as two initial state reference characteristics a predetermined number of times, such as, once, twice or several times.

A further embodiment of the measuring method can comprise repeating checking the plausibility and/or replacing the test strip at least once, such as twice or serval times or up to a predetermined maximum number of times; and generating a general error message in case after the repetition, such as after a repletion for the predetermined maximum number of times still and implausible evaluation result and/or an implausible determined characteristic occurs and/or the initial state result and/or comparing the determined initial state characteristic does not meet the initial state reference value, such as two initial state reference values, and/or the initial state reference characteristic, such as two initial state reference characteristics.

As to the advantages, embodiments and details of the individual different embodiments, reference is also made to the corresponding advantages, embodiments and details described with reference to the respective other embodiments.

Further embodiments result from the combination of individual, several or all of the features described herein.

### BRIEF DESCRIPTION OF THE DRAWINGS

The embodiments are described with reference to the attached drawings, in which

FIG. 1 illustrates a schematic depiction of an exemplary prior art reprocessing apparatus for medical instruments;

FIG. 2 illustrates a schematic depiction of an exemplary embodiment of a reprocessing apparatus for medical instruments;

FIG. 3 illustrates a schematic depiction of an arrangement for measuring a concentration of reprocessing agents in a reprocessing liquid used in the reprocessing apparatus for medical instruments of FIG. 2 in more detail;

FIG. 4 illustrates a schematic depiction of an exemplary embodiment of a transport arrangement for transporting a test strip connected to an arrangement for measuring a concentration of reprocessing agents in a reprocessing liquid used in a reprocessing apparatus for medical instruments;

FIG. 5 illustrates a schematic top view of the transport arrangement of FIG. 4;

FIG. 6 illustrates a schematic flow diagram of an exemplary embodiment of a transport method for transporting a test strip;

FIG. 7 illustrates a schematic flow diagram of an exemplary embodiment of a measuring method for automatically measuring a concentration of reprocessing agents in a reprocessing liquid used in a reprocessing apparatus for medical instruments;

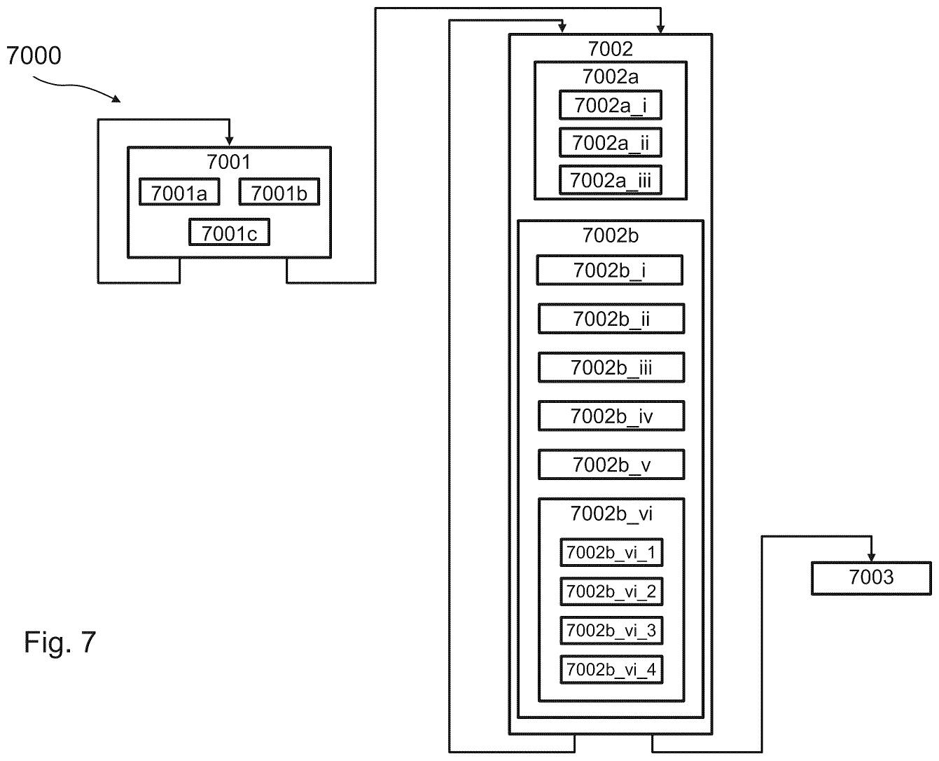

FIG. 8 illustrates a schematic flow diagram of an exemplary embodiment of a measuring method for automatically measuring a concentration of reprocessing agents in a reprocessing liquid used in a reprocessing apparatus for medical instruments and handling erroneous measurements.

### DETAILED DESCRIPTION

In the figures, elements with the same or comparable functions are indicated with the same reference numerals.

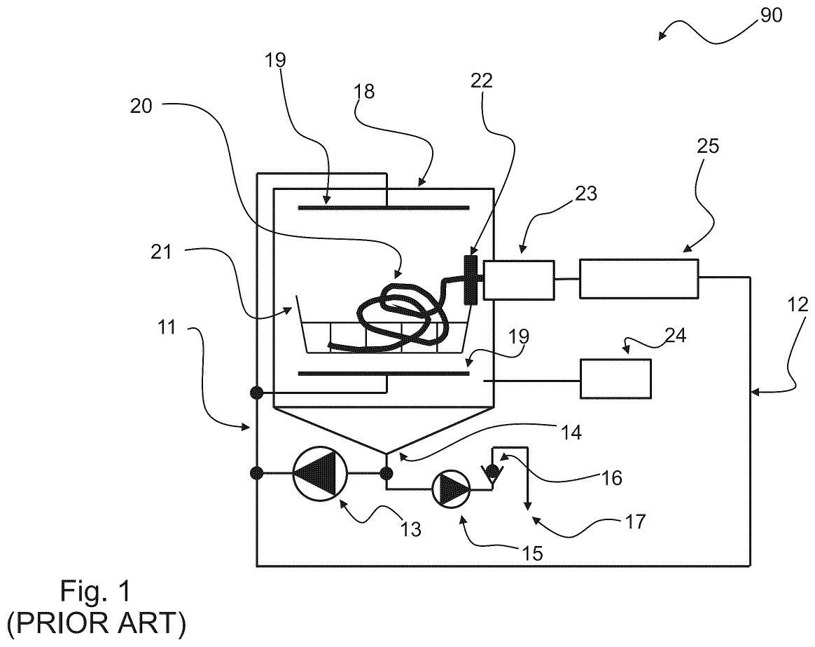

FIG. 1 shows a schematic layout of an exemplary prior art reprocessing apparatus 90 for medical instruments 20, for example endoscopes. The apparatus 90 may comprise a reprocessing chamber 18, in which a loading carrier 21 containing medical instruments 20 to be cleaned and/or disinfected and/or sterilized may be placed. Reprocessing liquid may be circulated in the apparatus 90 via circulation pump 13 and pump sump 14 in an outer reprocessing circuit 11 and an inner reprocessing circuit 12. The outer reprocessing circuit 11 may circulate the reprocessing liquid in the processing chamber 18 via at least one, such as, via two spray arms 19, as shown in FIG. 1. The inner reprocessing circuit 12 may circulate the reprocessing liquid via a monitoring unit 25, loading carrier 21 and loading carrier coupling 23 to the inner channels of medical instruments 20 located in loading carrier 21. The monitoring unit can be a “flow control,” which can be a dedicated module that monitors for blockages and dropped adapters. Such monitoring can operate by analyzing pressure differences. The values of which can be communicated via a so-called type list. The monitoring unit therefore also includes sensors, such as pressure sensors. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

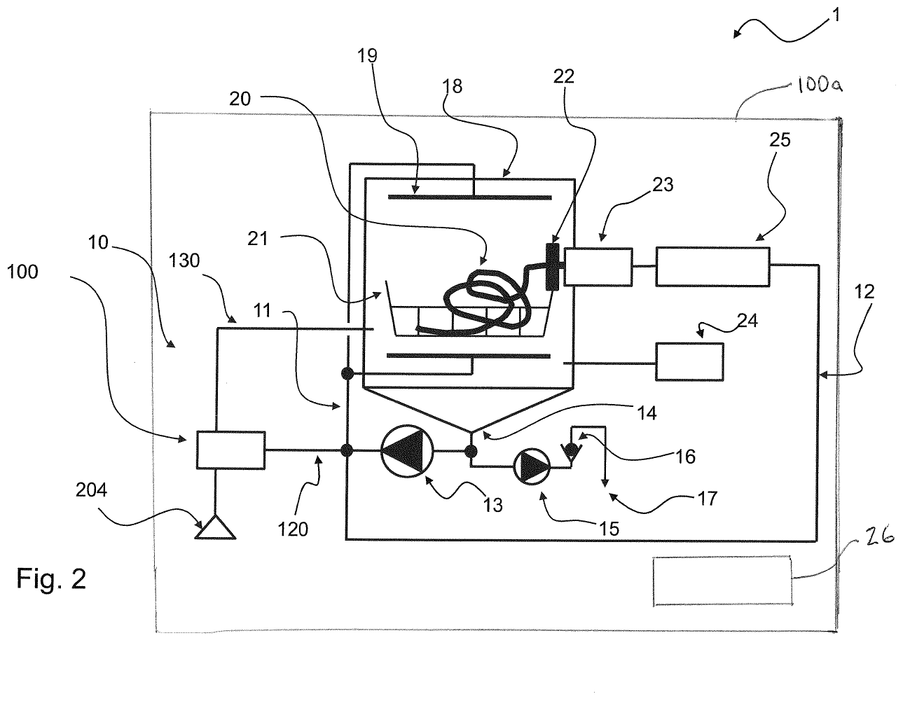

FIG. 2 shows a schematic layout of an exemplary embodiment of a reprocessing apparatus 1 for medical instruments 20, for example endoscopes. The individual components of the reprocessing apparatus 1, as discussed below, can be under the control of a controller 26 for carrying our such reprocessing. Also reprocessing apparatus 1 may comprise a reprocessing chamber 18, in which a loading carrier 21 containing medical instruments 20 to be cleaned and/or disinfected and/or sterilized may be placed. Reprocessing liquid may be circulated in the reprocessing apparatus 1 via circulation pump 13 and pump sump 14 in an outer reprocessing circuit 11 and an inner reprocessing circuit 12. The outer reprocessing circuit 11 may circulate the reprocessing liquid in the processing chamber 18 via least one, such as two spray arms 19. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The reprocessing apparatus 1 differs from existing reprocessing apparatus 90 for example in an arrangement (apparatus) 10 for measuring a concentration of reprocessing agents in a reprocessing liquid and a compressed air supply 204. The individual components of the measuring arrangement 10, as discussed below, can be under the control of a controller for measuring a concentration of reprocessing agents in a reprocessing liquid and a compressed air supply, as also discussed below. Such controller can be the same controller as that which controls the reprocessing apparatus or separate therefrom.

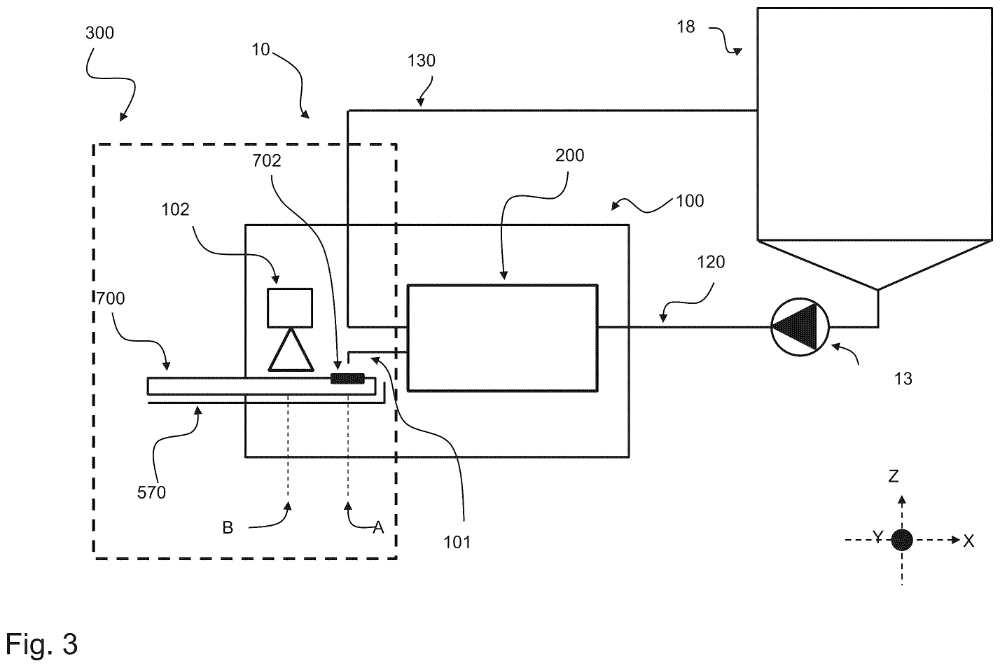

FIG. 3 shows a schematic depiction of an arrangement 10 for measuring a concentration of reprocessing agents in a reprocessing liquid used in the reprocessing apparatus 1 for medical instruments of FIG. 2 in more detail.

The arrangement 10 comprises a measuring system 100 connected to the reprocessing circuits 11, 12, such as to the circulation pump 13, via a first conduit 120 hydraulic connection of the measuring system. Furthermore, the measuring system 100 is connected to the reprocessing chamber 18 via a second conduit 130 for a bypass connection. The first and second conduits can form a bypass circuit for reprocessing liquid to be fed through measuring system 100. The measuring system 100 may be further connected to a compressed air supply 204.

During operation of the apparatus 1, one or several medical instruments 20 are placed into the loading carrier 21 and connected via the adapter plate 22 and the loading carrier coupling 23 to the inner reprocessing circuit 12 for rinsing the inner channel(s) of the medical instrument(s) 20 with reprocessing fluid.

The reprocessing chamber 18 may be filled with reprocessing liquid containing a reprocessing agent using spray arms 19 via the outer reprocessing circuit 11. The reprocessing chamber 18 may hold the reprocessing liquid for a predetermined amount of time. Alternatively and/or additionally, the circulation pump 13 may be used to re-circulate the reprocessing liquid containing the reprocessing agent by pumping it via the circulation pump 13 from the pump sump 14 to the spray arms 19 in the outer reprocessing circuit 11 and/or to the inner channel(s) of the medical instrument(s) 20 in the inner reprocessing circuit 12 for a pre-determined amount of time and/or number of cycles.

During cycling, reprocessing liquid may be taken from the outer reprocessing circuit 11 via the first conduit 120 to supply it to the measuring system 100, in which the concentration of the reprocessing agent in the reprocessing liquid is measured.

Dosing unit 24 may supply additional reprocessing agent according to the measurements of measuring system 100. The dosing unit may be an actuator, such as a motor, under the control of the controller. Such controller can be the same or separate from the controllers discussed above. After measuring the concentration of the reprocessing agent, the remaining reprocessing liquid may be fed back to the outer reprocessing circuit 11 via the second conduit 130.

At the end of a reprocessing procedure, such as after a pre-determined amount of time and/or number of recirculation cycles with a required concentration of reprocessing agents in the reprocessing liquid, the reprocessing chamber 18 may be emptied via the structural drain 17 by using the drain pump 15 for pumping the liquid through the check valve 16 into the structural drain 17.

The measuring system 100 may be located outside of a housing 100a of the apparatus 1 or may have an interface on an outer periphery of the apparatus 1.

The measuring system 100 is configured to receive a test strip 700 with a test surface 702 and to position the test strip 700 in a first, dosing position A and a second, measuring position B, both located along a test strip guide 570, as can be seen in FIG. 3. The measuring system 100 is further configured to dose a predetermined amount of reprocessing liquid onto the test surface 702 when the test strip 700 is positioned in the first, dosing position A via a reprocessing liquid feed system and a sample feed line 101 connected thereto.

The measuring system 100 can comprise an evaluating unit 102 for measuring the concentration of reprocessing agents in the reprocessing liquid when the test strip 700 is positioned in the second, measuring position B by evaluating the test surface 702. The evaluating unit 102 may comprise an optical spectrometer and/or an RGB color sensor, and the evaluating unit 102 may be configured to compare the evaluation result with a reference value. For example a characteristic, such as a color characteristic, of the test surface 702 may be determined, and compared with a reference characteristic. The predetermined amount of reprocessing liquid may act on the test surface 702 for a predetermined exposure time before evaluating the test surface 702. After evaluating the test surface 702, the test strip 700 is released.

The arrangement 10 for measuring a concentration of reprocessing agents in a reprocessing liquid used in a reprocessing apparatus 1 for medical instruments 20, can further comprise a transport arrangement (apparatus) 300 for transporting a test strip 700. The transport arrangement 300 may be used for transporting a test strip 700. A single test strip 700 can be transported. The individual components of the transport arrangement 300, as discussed below, can be under the control of a controller for controlling the transport process of transporting the test strip 700, as also discussed below. Such controller can be the same or separate from the controllers discussed above.

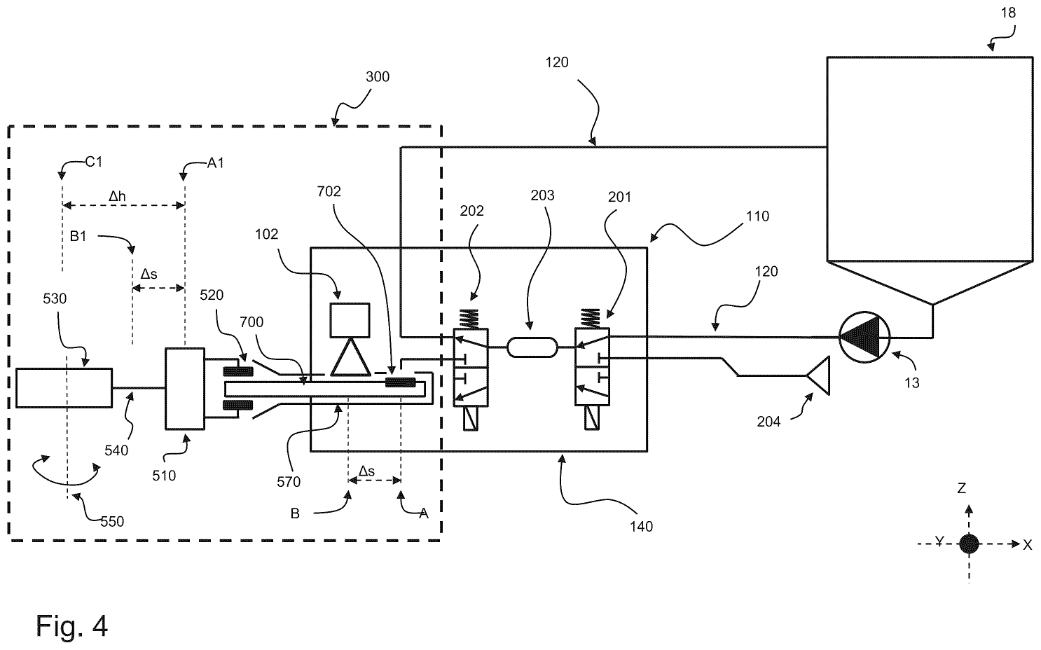

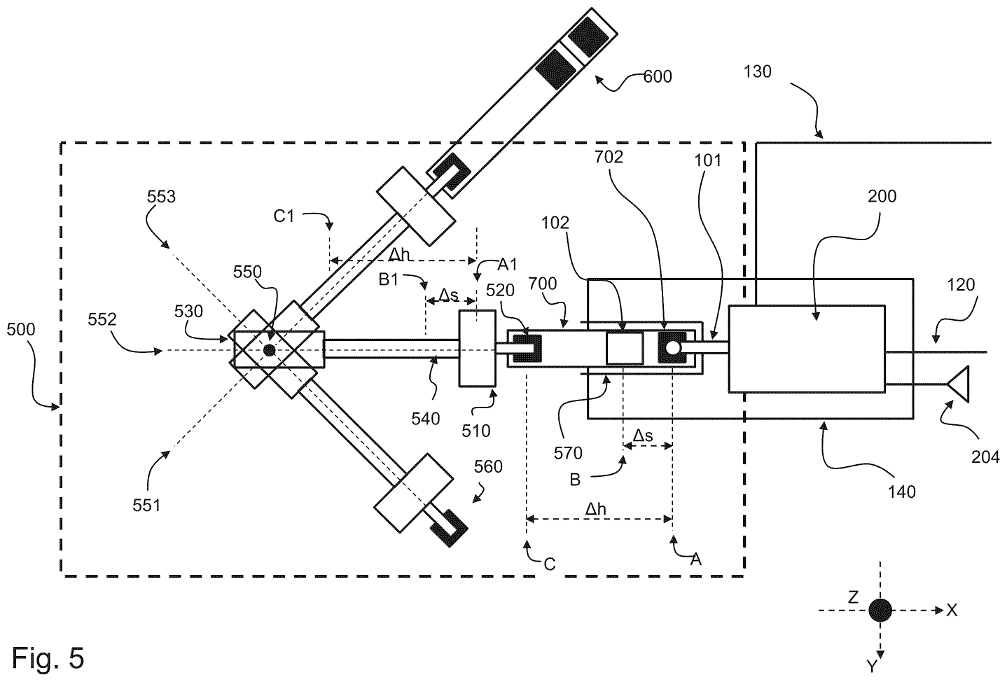

The arrangement 10 for measuring a concentration of reprocessing agents in a reprocessing liquid used in a reprocessing apparatus 1 for medical instruments 20, can further comprise a reprocessing liquid feed system 200 for dosing a predetermined amount of reprocessing liquid onto a test surface 702 of a test strip 700, which is shown in more details in FIGS. 4 and 5.

The reprocessing liquid feed system 200 comprises a first directional control valve 201 having two valve inlets and one valve outlet and a second directional control valve 202 having one valve inlet and two valve outlets.

As can be seen in FIG. 4, one of the two valve inlets of the first directional control valve 201 is connected to a first conduit 120 for a hydraulic connection of a measuring system with a reprocessing circuit 11, 12 of the reprocessing apparatus 1 and the other one of the two valve inlets of the first directional control valve 201 is connected to a compressed air line connected to a compressed air supply 204 and the valve outlet of the first directional control valve 201 is connected to the valve inlet of the second directional control valve 202.

As can further be seen in FIG. 4, one of the two valve outlets of the second directional control valve 202 is connected to a second conduit 130 for a bypass connection of the measuring system 100 back into a reprocessing chamber 18 of the reprocessing apparatus 1 and the other one of the two valve outlets of the second directional control valve 202 is connected to a sample feed line 101 for dosing a predetermined amount of reprocessing liquid onto a test surface 702 of a test strip 700.

Between the first and the second directional control valves 201, 202 a specified volume 203 is defined.

In a first, flow-through state, the first and the second directional control valves 201, 202 are not activated and a liquid connection for reprocessing liquid is formed between the first conduit to the second conduit through the first and the second directional control valves 201, 202 and the specified volume 203.

In a second, preparatory state, the first directional control valve 201 is activated and the second valve inlet of the first directional control valve 201 is subjected to compressed air, causing the specified volume 203 containing reprocessing liquid to partially fill with air.

In a third, dosing state, the second directional control valve 202 is activated and a fluid connection is formed between the compressed air line to the sample feed line 101 through the first and the second directional control valves 201, 202 and the specified volume 203.

In a fourth, drying state, the fluid connection formed between the compressed air line to the sample feed line 101 through the first and the second directional control valves 201, 202 and the specified volume 203 is drained of reprocessing liquid.

In a fifth, continued flow-through state, the first and second directional control valves 201, 202 are deactivated and a liquid connection for reprocessing liquid is formed between the first conduit to the second conduit through the first and the second directional control valves 201, 202 and the specified volume 203.

Further, the reprocessing liquid feed system 200 is adapted to activate the second directional control valve 202 when a predetermined amount of reprocessing fluid is present in the specified volume 203.

The transport arrangement 300 can comprise a gripper 510 configured to grip a test strip 700, such as a portion or end of the test strip 700 opposite the portion of end of the test strip 700 containing the test surface 702. The gripper 510 comprises two gripper jaws 520, wherein the two gripper jaws 520 can be movable from a gripping position to a release position and vice versa, such as via a gripping drive. The gripping drive may be an actuator, such as a motor, under the control of the controller. Such controller can be the same or separate from the controllers discussed above.

The gripper 510 is arranged moveably, such as translationally moveably, along a longitudinal axis via a translational drive, such as a linear drive 530, for example via a coupling rod 540. The linear drive may be an actuator, such as a motor, under the control of the controller.

Further, the gripper 510 is arranged to move the test strip 700, such as the test surface 702, between a first, dosing position A and a second, measuring position B, and can also move the test strip to a third, relocation position C, which are located along the longitudinal axis. Further, the gripper 510 is coupled to the translational drive via a coupling rod. The longitudinal distance between the first, dosing position A and the second, measuring position B is indicated with Δs in FIGS. 4 and 5. The longitudinal distance between the first, dosing position A and third, relocation position C is indicated with Δh In FIG. 5. FIGS. 4 and 5 also indicate the corresponding positions A1, B1 and C1 of the gripper 510 when the test strip 700 is in positions A, B, and C.

Further, as is best seen in FIG. 5, the gripper 510 is arranged rotatably about a rotation axis 550 via a rotational drive and is arranged to be rotatable to a first rotational, supply position 551 and a second rotational, operational position 552, and/or a third rotational, discharge position 553. The rotational drive may be an actuator, such as a motor, under the control of the controller.

The gripper 510 is configured to be positioned in the first, dosing position A and the second, measuring position B, and/or the third, relocation position C, and any other position along the longitudinal axis within an overall translational or longitudinal stroke, independent from the rotational orientation of the gripper 510.

Further, the gripper 510 is configured to be positioned in first rotational, supply position 551 and the second rotational, operational position 552, and/or the third rotational, discharge position 553, and any other rotational position about the rotational axis within an overall rotational stroke, independent from the translational or longitudinal position of the gripper 510.

The first rotational, supply position 551 can serve to grip a new test strip 700 from a test strip depot 600. the gripper 510 with new test strip 700 is then rotated to the second rotational, operational position 552, while at the same time along the longitudinal axis the gripper 510 is in position C1 corresponding to the test strip being in the third, relocation position C. In this second rotational, operational position 552, the gripper 510 can then be brought into position A1 corresponding to the test strip being in the first, dosing position A. Once the test strip 700 has been exposed to a dose of reprocessing liquid dosed on the test surface 702 via sample feed line 101, the gripper 510 can be brought into position B1 corresponding to the test strip being in the second, measuring position B, where the test surface 702 is being evaluated. Once the surface 702 has been evaluated, the gripper 510 can be retracted to position C1 corresponding to the test strip being in the third, relocation position C and then rotated to the third rotational, discharge position 553, where the now used test strip 700 can be disposed of and released to a collecting area 560 by releasing the gripper jaws 520.

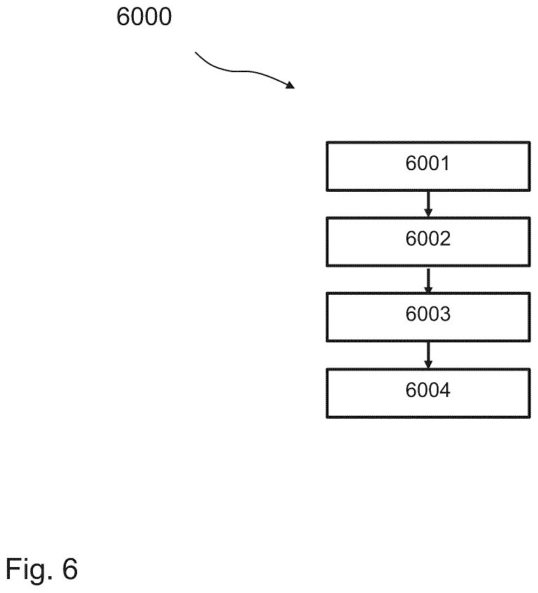

The transport arrangement 300 can be used in the following exemplary transport method 6000 for transporting a test strip 700 shown in FIG. 6. This transport method 6000 starts with step 6001 of gripping a test strip 700 as a preparation for the step 6002 of moving, such as translationally or longitudinally, the test strip 700 between a first, dosing position A and a second, measuring position B, and/or a third, relocation position C, such as along a longitudinal axis. It also comprises the step 6003 of rotating the test strip 700 between a first rotational, supply position 551 and a second rotational, operational position 552, and/or a third rotational, discharge position 553, about a rotational axis. Finally in step 6004, the test strip 700 in the third rotational, discharge position 553, is released, such as to a collecting area 560.

The step 6001 of gripping the test strip 700 occurs in the first rotational, supply position 551, for example, in order to grip the test strip 700 from an arrangement for separating test strips 700 from a test strip depot 600.

The steps of the exemplary transport method 6000 for transporting a test strip 700 can be part of a measuring method 7000 for automatically measuring a concentration of reprocessing agents in a reprocessing liquid used in a reprocessing apparatus 1 for medical instruments 20.

The first, dosing position A and the second, measuring position B can be located within an arrangement 10 for measuring a concentration of reprocessing agents in a reprocessing liquid used in a reprocessing apparatus 1 for medical instruments 20, such as within a measuring system 100 of the arrangement 10 for measuring a concentration of reprocessing agents in a reprocessing liquid used in a reprocessing apparatus 1 for medical instruments 20.

The transport arrangement 300 may be used with an exemplary measuring method 7000 shown in FIG. 7000. The exemplary measuring method 7000 can comprise the step 7001 of checking the plausibility of an evaluation result and/or a determined characteristic and replacing 7002 the test strip 700 in case of an implausible evaluation result and/or an implausible determined characteristic.

The step 7002 of replacing the test strip 700 comprises the step 7002a of removing the test strip 700 from the measuring system 100; and the step 7002b of providing a new test strip 700 to the measuring system 100.

The step 7002a of removing the test strip 700 from the measuring system 100 can comprise the step 7002a_i of moving the gripper 510 to the third, relocation position; the step 7002a_ii of rotating the gripper 510 to the third rotational, discharge position; and the step 7002a_iii of moving the two gripper jaws to the release position.

The step 7002b of providing a new test strip 700 to the measuring system 100 can comprise the step 7002b_i of rotating the gripper 510 to the first rotational, supply position 551; the step 7002b_ii of moving the two gripper jaws 520 to the gripping position to grip the new test strip 700, in an arrangement for separating test strips 700 from a test strip depot 600; the step 7002b_iii of rotating the gripper 510 to the second rotational, operational position 552; the step 7002b_iv of moving the gripper 510 to the first, dosing position A; and the step 7002b_v of moving the gripper 510 to the second, measuring position B.

The step 7001 of checking the plausibility of an evaluation result and/or a determined characteristic can comprise the step 7001a of comparing the evaluation result with a plausibility reference value and/or the step 7001b of comparing the determined characteristic with a plausibility reference characteristic; and the step 7001c of generating a plausibility error message in case an implausible evaluation result and/or an implausible determined characteristic occurs a predetermined number of times, such as once, twice or several times.

The step 7002b of providing a new test strip 700 to the measuring system 100 can comprise the step 7002b_vi of checking the initial state of the new test strip 700, in the second, measuring position B and/or prior to moving the new test strip 700 to the first, dosing position A, such as prior to dosing a predetermined amount of reprocessing liquid onto the test surface 702.

The step 7002b_vi of checking the initial state of the new test strip 700 can comprise the step 7002b_vi_1 of measuring the initial state of the new test strip 700 by using an evaluation unit 102, such as an optical spectrometer and/or an RGB color sensor; and/or the step 7002b_vi_2 of measuring the initial state of the new test strip 700 by determining an initial state characteristic, such as a color characteristic, of the test surface of the new test strip 700; and/or the step 7002b_vi_3 of comparing the initial state result with an initial state reference value, such as two initial state reference values, and/or comparing the determined initial state characteristic with an initial state reference characteristic, such as two initial state reference characteristics; the step 7002b_vi_4 of generating an initial state error message in case the initial state result and/or comparing the determined initial state characteristic does not meet the initial state reference value, two initial state reference values, and/or the initial state reference characteristic, such as two initial state reference characteristics, once, twice or several times.

The steps 7001, 7002 of checking the plausibility and/or replacing the test strip 700 can be repeated at least once, twice or serval times or up to a predetermined maximum number of times.

In step 7003 a general error message can be generated in case after the repetition, such as after a repletion for the predetermined maximum number of times still and implausible evaluation result and/or an implausible determined characteristic occurs and/or the initial state result and/or comparing the determined initial state characteristic does not meet the initial state reference value, such as two initial state reference values, and/or the initial state reference characteristic, such as two initial state reference characteristics.

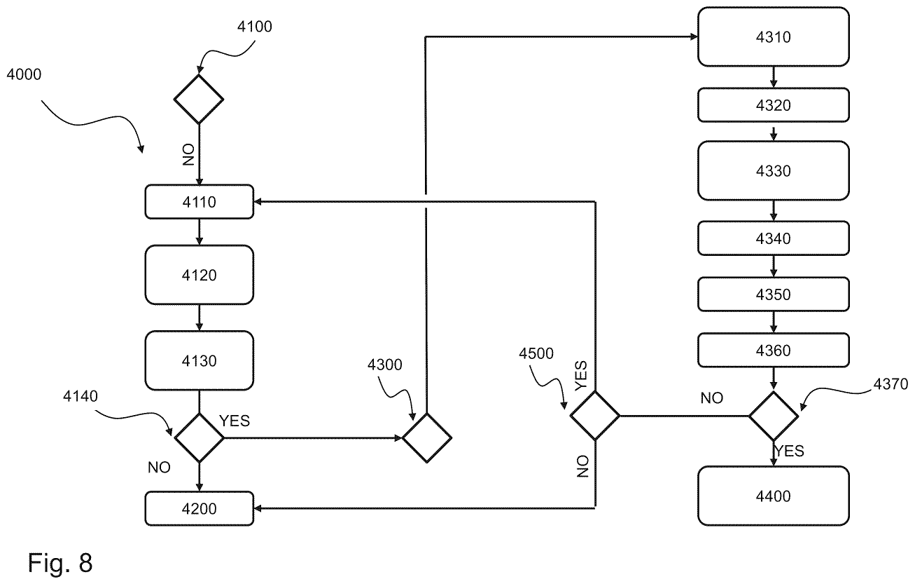

FIG. 8 shows a schematic flow diagram of a further exemplary embodiment of a measuring method 4000 for automatically measuring a concentration of reprocessing agents in a reprocessing liquid used in a reprocessing apparatus 1 for medical instruments 20 and handling erroneous measurements.

In step 4100 it is checked whether the measurement was successful. If not, the test strip 700 is discarded in step 4110 and a new step strip 700 used in step 4120. Then an initial state reference measurement of the test strip 700 is performed in step 4130. In step 4140 it is checked whether the initial state result is in the reference range. If not, an error message is generated in step 4200. If the initial state result is in the reference range, it is determined in step 4300 whether a further measurement repetition shall be performed. If so, the test surface 702 is brought to the dosing position A in step 4310, reprocessing liquid is dosed onto test surface 702 in step 4320, and the test surface 702 is brought to the measurement position B in step 4330. The reprocessing liquid acts on the test surface 702 for a predetermined exposure time in step 4340 before evaluating the test surface 702 in step 4350. This result is then compared to a reference value in step 4360. In step 4370 it is checked whether the reference value is met. If so, reprocessing continues in step 4400. If not, it is checked whether a further measurement repetition is admissible. If so, the procedure continues with step 4110. If not, an error message is generated in step 4200.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A transport apparatus for transporting at least one test strip, the transport apparatus comprising:
a gripper configured to grip a portion of the at least one test strip;
wherein the gripper is arranged to move the test strip between at least a first dosing position and a second measuring position.

2. The transport apparatus according to claim 1, wherein the at least one test strip comprises a single test strip.

3. The transport apparatus according to claim 1, wherein the portion of the at least one test strip comprises a first end of the test strip opposite to a second end of the test strip containing a test surface.

4. The transport apparatus according claim 1, wherein the gripper is arranged moveably along a longitudinal axis.

5. The transport apparatus according to claim 4, wherein the gripper is movable translationally along the longitudinal axis.

6. The transport apparatus according to claim 4, wherein a first dosing position and a second measuring are located along the longitudinal axis.

7. The transport apparatus according to claim 5, wherein the gripper is translationally moveable along the longitudinal axis via a translational drive and the gripper is coupled to the translational drive via a coupling rod.

8. The transport apparatus according to claim 1, wherein the gripper is additional movable to a third relocation position.

9. The transport apparatus according to claim 1, wherein one or more of:
the gripper is arranged rotatably about a rotation axis;
the gripper is rotatable about the rotation axis via a rotational drive; and
the gripper is arranged to be rotatable to a first rotational supply position and a second rotational operational position.

10. The transport apparatus according to claim 9, wherein the gripper is arranged to be further rotatable to a third rotational discharge position.

11. The transport apparatus according claim 4, wherein one or more of:
the gripper is configured to be positioned in any position along the longitudinal axis within an overall translational or longitudinal stroke, independent from a rotational orientation of the gripper; and
the gripper is configured to be positioned in any rotational position about a rotational axis within an overall rotational stroke, independent from the translational or longitudinal position of the gripper.

12. The transport apparatus according to claim 1, wherein the gripper comprises two gripper jaws, and the two gripper jaws are movable from a gripping position to a release position and vice versa.

13. The transport apparatus according to claim 12, wherein the two gripper jaws are movable via a gripping drive.

14. A measuring apparatus for measuring a concentration of reprocessing agents in a reprocessing liquid used in a reprocessing apparatus for medical instruments, the measuring apparatus comprising the transport apparatus according to claim 1.

15. A reprocessing apparatus for medical instruments, the reprocessing apparatus comprising
a reprocessing chamber;
a reprocessing circuit;
a measuring apparatus for measuring a concentration of reprocessing agents in a reprocessing liquid; and
the transport apparatus according to claim 1, for transporting the at least one test strip to the measuring apparatus for measuring the concentration of reprocessing agents in the reprocessing liquid.

16. A transport method for transporting at least one test strip, the transport method comprising
gripping the at least one test strip;
moving the test strip between a first dosing position and a second measuring position.

17. The transport method according to claim 16, wherein the moving comprises one or more of:
rotating the at least one test strip between a first rotational supply position and a second rotational operational position; and
releasing the at least one test strip in a third rotational, discharge position.

18. The transport method according claim 17, wherein the gripping occurs in the first rotational supply position.

19. A measuring method for automatically measuring a concentration of reprocessing agents in a reprocessing liquid used in a reprocessing apparatus for medical instruments, the method comprising:
transporting the at least one test strip according to claim 16;
wherein the first dosing position and the second measuring position are located within an arrangement for measuring a concentration of reprocessing agents in a reprocessing liquid used in a reprocessing apparatus for medical instruments.

20. The measuring method according to claim 19, further comprising
checking the plausibility of one or more of an evaluation result and a determined characteristic and replacing the test strip in case of one or more of the implausible evaluation result and the implausible determined characteristic.

21. The measuring method according to claim 20, wherein the replacing of the test strip comprises:
removing the test strip; and
providing a new test strip.

22. The measuring method according to claim 21, wherein the removing of the test strip comprises:
moving the gripper to a third relocation position; and
rotating the gripper to a third rotational discharge position.

23. The measuring method according to claim 21, wherein the providing of the new test strip comprises:
rotating the gripper to a first rotational supply position;
moving two gripper jaws of the gripper to a gripping position to grip the new test strip;
rotating the gripper to a second rotational, operational position;
moving the gripper to the first dosing position; and
moving the gripper to the second measuring position.

24. The measuring method according to claim 20, wherein the checking of the plausibility of one or more of the evaluation result and the determined characteristic comprises:
one or more of comparing the evaluation result with a plausibility reference value and comparing the determined characteristic with a plausibility reference characteristic.

25. The measuring method according to claim 21, wherein the providing of the new test strip comprises:
checking an initial state of the new test strip.

26. The measuring method according to claim 25, wherein the checking of the initial state of the new test strip comprises one or more of:
measuring the initial state of the new test strip using an evaluation unit; and/or
measuring the initial state of the new test strip by determining an initial state characteristic; and
comparing the initial state result with an initial state reference value, and comparing the determined initial state characteristic with an initial state reference characteristic.

27. The measuring method according to claim 25, further comprising:
repeating the checking of the plausibility a predetermined number of times.
